(19) United States
(12) Patent Application Publication
(10) Pub. No.: US 2014/0364083 A1
(43) Pub. Date: Dec. 11, 2014

(54) SYSTEM AND METHOD FOR VOICE OPERATED CALLING CARD

(71) Applicant: Michael D. Metcalf, Lake Forest, CA (US)

(72) Inventor: Michael D. Metcalf, Lake Forest, CA (US)

(21) Appl. No.: 14/295,340

(22) Filed: Jun. 4, 2014

Related U.S. Application Data
(60) Provisional application No. 61/831,439, filed on Jun. 5, 2013.

(51) Int. Cl. H04M 15/00; H04W 8/18

(52) U.S. Cl. CPC H04M 15/715; H04W 8/18; H04M 15/61
USPC 455/406; 455/418

(57) ABSTRACT

A voice operated calling card system and method. In one embodiment, there is provided a communications device, such as a mobile phone, for example, and a hosted application configured to accept voice commands and further configured to associate a user of the communications device with a calling card. The calling card may have funds associated with it. When a user places a call into the hosted application, the hosted application may allow the user of the communications device to purchase a service using the funds associated with the calling card, such as placing a long distance telephone call, for example.

### CROSS-REFERENCE TO RELATED APPLICATION

This application claims the benefit of priority to U.S. Patent Application No. 61/831,439, filed Jun. 5, 2013, the contents of which are fully incorporated herein by reference.

### BACKGROUND

Consumers traditionally have used calling cards to make low-cost long distance calls. To use a calling card, a consumer would typically dial an access number, such as a local number or a toll free number, and then wait for the calling card platform to answer the call. Next, the consumer will typically enter a personal identification number (PIN) number through the telephone, and then enter a destination number which will typically include a country code and telephone number associated with the country of the destination number. The entering of all these numbers is tedious and cumbersome and discourages use of the calling card.

### SUMMARY OF THE INVENTION

It is an object of the present invention to provide a system for voice operated communication assistance. Embodiments of the present invention may include a communications device, the communications device being able to communicatively couple to a network; and an application hosted by an application server, the application server communicatively coupled to a network. The application may be configured to accept a voice command from the communications device, may be further configured to associate a user of the communications device access to with a calling card. The communications device may be a mobile telephone and the mobile telephone may be a smartphone. The communications device may be an analog telephone

According to an embodiment of the present invention, the application may associate the user of the mobile telephone with the calling card using a telephone number of the mobile telephone. Also, the application may associate funds with the calling card. The calling card may purchase a service using the funds, and the service may be long distance telephone calling.

It is yet another object of the present invention to provide a system for voice operated communication assistance. Embodiments of the present invention may include providing a communications device, the communications device being able to communicatively couple to a network; and providing an application hosted by an application server, the application server communicatively coupled to a network. The application may be configured to accept a voice command from the communications device, may be further configured to associate a user of the communications device access to with a calling card. The communications device may be a mobile telephone and the mobile telephone may be a smartphone. The communications device may be an analog telephone.

### BRIEF DESCRIPTION OF THE DRAWINGS

FIG. 1 shows a block diagram of a voice operated calling card system according to an embodiment of the present invention.

FIG. 2 shows a method for a voice operated calling card according to an embodiment of the present invention.

FIG. 3 shows a method for a voice operated calling card according to yet another embodiment of the present invention.

FIG. 4 shows a method for a voice operated calling card according to yet another embodiment of the present invention.

FIG. 5 shows a method for a voice operated calling card according to yet another embodiment of the present invention.

FIG. 6 shows a method for a voice operated calling card according to yet another embodiment of the present invention.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized without departing from the scope of the present invention.

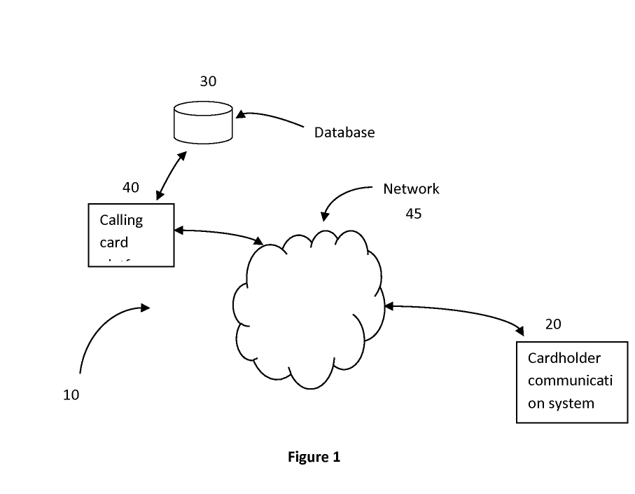

A system for a voice operated calling card system 10 according to an embodiment of the present invention is shown in FIG. 1. FIG. 1 includes, for example, a cardholder communication device 20 and a calling card platform 40. The cardholder communication device 20 and the calling card platform 40 may both be connected to a network 45.

The network 45 may be a telephone or telecommunications network. For example, the network 45 may be a public or private network, a local area network or a wide area network, or may be the Internet. According to an embodiment of the present invention, the network 45 may be a wired network, such as a public switched telephone network, for example, which may include a network of physical wires like copper wires. Alternatively, the network 45 may be a network of fiber optic cables. According to another embodiment of the present invention, the network 45 may be a wireless telephone network such as the type used by mobile telephones in a cellular telephone system. According to another embodiment of the present invention, the network 45 may be a “WiFi” network or may be a voice over Internet protocol (VoIP) network. According to yet another embodiment of the present invention, the network 45 may be a combination of a wired network and a wireless network.

The cardholder communication device 20 may be any type of communication device with which a cardholder may communicate with another person or another device. Alternatively, the cardholder communication device 20 may be a communication system. For example, according to an embodiment of the present invention, the cardholder communication device 20 may be a traditional analog telephone system. Alternatively, the cardholder communication device 20 may be a simple residential telephone, a cordless phone, a mobile telephone, a smartphone, a feature phone or any other communication device into which voice signals or voice commands can be spoken.

According to the embodiment of the invention shown in FIG. 1, if the Internet is or is part of the network 45, the cardholder communication device 20 may be communicatively coupled to a network adapter. The network adapter may be a VoIP adapter, configured to accept voice or analog signals and convert such signals to data suitable for transmission over a data network. VoIP adapters are well-known in the art. The network adapter is then communicatively coupled to the network 45 such that the cardholder communication device 20, through the network adapter, may access the network 45.

The network adapter may be configured so that, upon receiving a predetermined telephone number from the cardholder communication device 20, the network adapter redirects a cardholder using the cardholder communication device 20 to the calling card platform 40. According to an embodiment of the present invention, the network adapter may be configured such that the cardholder communication device 20 is redirected to the calling card platform 40 using session initiation protocol (SIP).

The calling card platform 40 shown in FIG. 1 may be a hosted application. For example, according to an embodiment of the present invention, the calling card platform 40 may include a software program that resides on a computer system or a smartphone. For example, the calling card platform 40 may include a computer system having a processor coupled to a memory, storage, a network interface and an I/O interface. The processor may be one or more microprocessors and may include other logic circuits. The memory may include RAM, ROM, DRAM, SRAM and the like, and may include firmware, such as static data or fixed instructions, BIOS, system functions, configuration data, and other routines used during the operation of the processor. The memory may also provide a storage unit for data and instructions associated with applications and data handled by the processor. The storage unit provides non-volatile long term storage of data or instructions in the computer system. The storage unit may take the form of a disk, optical storage, SAN, tape, CD, DVD, or other reasonably high capacity addressable storage medium. In addition, the calling card platform 40 may include one or more databases 30 in which information is stored and organized. The databases 30 may be relational databases, hierarchical databases, and the like.

According to an embodiment of the present invention, the calling card platform 40 may be implemented as a website resident on a server computer. For example, the server computer may be programmed such that an application generates a website available to cardholders over a network. According to an embodiment of the present invention, cardholders calling the calling card platform 40 may access the application hosted by the server computer via a website on the Internet.

According to yet another embodiment of the present invention, the calling card platform 40 may be hosted on telephony application servers or trunk servers that are communicatively coupled to the network 45. The telephony application servers or trunk servers may be configured for voice recognition and speech and may be referred to generically as speech servers. For example, if the network 45 is a wired or wireless telephone network 45, the calling card platform 40 may provide computer telephony integration such that a cardholder placing a call via the cardholder communication device 20 to the calling card platform 40 may access speech servers implemented in the calling card platform 40 via the telephone network 45. In this configuration, the speech servers implemented in the calling card platform 40 may answer a call from the cardholder.

The calling card platform 40 may be configured such that it accepts cardholders. According to an embodiment of the present invention, cardholders may enroll with the calling card platform 40 and enter information about themselves. According to an embodiment of the present invention, the calling card platform 40 may register a caller or calling card identification (ID) number for a cardholder who enrolls with the calling card platform 40. The calling card ID number may be a telephone number used by the cardholder or may be another number. Once enrolled, the calling card platform 40 may accept information about the cardholder that the cardholder would like to enter. The information may be stored and organized in one or more databases 30. Such information may include, for example, a contact list, an email address, social network account information, phone numbers, bank account numbers and the like. For example, a cardholder may enter the account information for the user's TWITTER and FACEBOOK accounts so that the calling card platform 40 will have this information readily available when the cardholder contacts the calling card platform 40. As another example, a cardholder may enter the names of persons or places that the cardholder typically calls and telephone numbers associated with those names so that the calling card platform 40 will have this information readily available when the cardholder contacts the calling card platform 40. As yet another example, a cardholder may enter the cardholder's bank account information so that the calling card platform 40 will have this information readily available when the cardholder contacts the calling card platform 40 if the cardholder needs to add additional funds to his or her calling card ID.

According to an embodiment of the present invention, the calling card platform 40 may be configured such that it utilizes voice recognition technology for entry of information. For example, the calling card platform 40 may be configured such that any information being entered into it, such as a telephone number or the name of a person or place, may be entered simply by a cardholder speaking into the cardholder's telephone.

According to an embodiment of the present invention, the calling card platform 40 may be configured such that when the network adapter redirects the cardholder communication device 20 to the calling card platform 40, the calling card platform 40 connects to the cardholder communication device 20 via the network 45 and logs into the cardholder account. The calling card platform 40 may log on to the cardholder account using a “caller ID,” “media access control (mac) ID,” or other identification mechanism associated with the cardholder communication device 20 as are well-known in the art.

A cardholder desirous of using the calling card platform 40 may purchase a calling card which may be used to purchase or in connection with automated services in a variety of ways. According to an embodiment of the present invention, a calling card may be a paper receipt purchased at a retail store that may include an access number and a PIN for the cardholder to dial. Alternatively, a calling card may be a physical card, such as a plastic card similar to a common credit card that may be purchased at a retail store, or may be a numerical or an electronic identification. For example, a cardholder may purchase a physical plastic calling card at a retail store that may include an access number and a PIN for the cardholder to dial. The cardholder may call the access number, access the system and enter the PIN on the card such that the PIN is unique to that cardholder. Once the PIN is entered, the cardholder is registered with the calling card platform 40 and may access the calling card platform 40 from any telephone.

According to an embodiment of the present invention, a cardholder may sign up for service with the calling card platform 40 by accessing a website associated with the calling card platform 40. Once at the website, the cardholder may enter his or her mobile phone number. The calling card platform 40 may then send a text message or other type of message to the mobile phone belonging to the cardholder that includes an access number and a PIN. After receipt of the access number and the PIN, the cardholder can then dial the access number using his or her mobile phone and enter the PIN. The PIN will then be associated with the cardholder's mobile phone and the cardholder will be able to automatically utilize the services provided by the calling card platform 40 simply by dialing the access number from the mobile phone to which the access number and PIN were sent. According to another embodiment of the present invention, the cardholder will be able to automatically utilize the services provided by the calling card platform 40 simply by depressing a speed dial key on the mobile phone to which the access number and PIN were sent.

A variety of other methods may be used to sign up or register for service with the calling card platform 40. For example, a cardholder may download an application, such as a mobile application, for example, to the cardholder's mobile phone, tablet computer, personal computer or the like. The application may be configured such that, as soon as the application is opened, the application automatically dials an access number for the calling card platform 40, thereby automatically connecting the cardholder to the calling card platform 40. According to another embodiment of the present invention, the application may be configured such that, as soon as the application is opened, a key is made available which, when pressed, causes the application to dial an access number for the calling card platform 40, thereby connecting the cardholder to the calling card platform 40. The cardholder may then configure his or her account in any manner offered by the calling card platform 40.

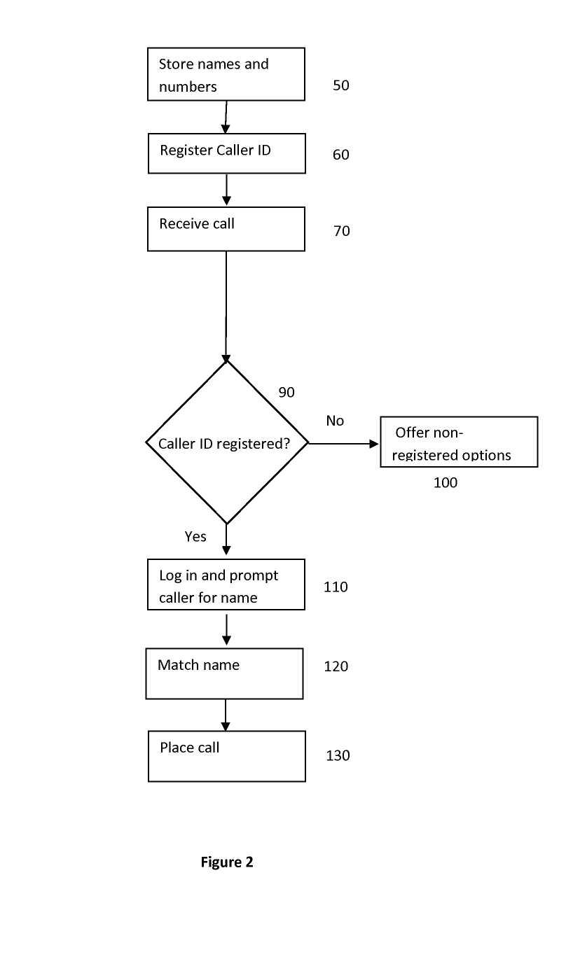

A method for a voice operated calling card system according to an embodiment of the present invention is shown in FIG. 2. In FIG. 2, at step 50 the names and associated telephone numbers of persons or places which a cardholder who has enrolled with the calling card platform 40 may call are stored in the calling card platform 40. The names and associated numbers may be stored in the calling card platform 40 in a variety of ways. For example, according to an embodiment of the present invention, the names and associated numbers may be stored by accessing a website associated with the calling card platform 40 and entering the names and the associated numbers at the website. Also, according to an embodiment of the present invention, the names stored may be the names of friends, family and other persons the cardholder typically calls. Alternatively, the names stored may be the names of places the cardholder typically visits or transacts business with, such as, for example, a restaurant or clothing store. The names and telephone numbers may be stored in one or more databases. For example, according to an embodiment of the present invention, the names and telephone numbers may be stored in a relational database.

Next, at step 60 in FIG. 2, the cardholder registers his or her calling card ID with the calling card platform 40. The calling card ID may be the cardholder's telephone number assigned to the cardholder's smartphone, feature phone, mobile phone, analog phone or other type of telephone. Alternatively, according to an embodiment of the present invention, the calling card ID may be another type of number that the cardholder wishes to use. The calling card ID may be registered with the calling card platform 40 by storing the calling card ID in a database associated with the calling card platform 40. The calling card ID may be registered over the telephone or may be registered at a website associated with the calling card platform 40.

At step 70 in FIG. 2, the calling card platform 40 receives a call from a cardholder. The cardholder may dial the calling card platform 40 from any telephone the cardholder may have available, such as a smartphone, feature phone, mobile phone, analog telephone and the like. According to an embodiment of the present invention, the number dialed by the cardholder may be a local telephone number or may be a toll-free telephone, such as, for example a telephone number that can be used by the cardholder from any location without charge.

After the calling card platform 40 receives a call from a cardholder, at step 90 the calling card platform 40 verifies that the cardholder's calling card ID has been registered with the calling card platform 40. For example, according to an embodiment of the present invention, if the cardholder, at step 60, registered his or her smartphone telephone number with the calling card platform 40 as the cardholder's calling card ID, then at step 90, if the cardholder calls the calling card platform 40 with the same smartphone with which the cardholder originally registered, the calling card platform 40 can automatically verify that the cardholder's calling card ID has been registered with the calling card platform 40 upon receipt of a call from that smartphone. Alternatively, according to an embodiment of the present invention, if the cardholder registered a calling card ID that is a telephone number of a telephone different from the one with which the cardholder is calling the calling card platform 40, then the calling card platform 40 may give the cardholder an option of entering a calling card ID. The calling card platform 40 may accept a calling card ID via voice command from the cardholder or, for example, via DTMF touch tones. In other words, according to an embodiment of the present invention, the cardholder may speak the calling card ID directly into the telephone. The calling card platform 40 may then use voice recognition technology or other technology well-known in the art to ascertain the calling card ID. Alternatively, the calling card platform 40 may accept a calling card ID by entry from the cardholder of a number on the telephone's DTMF keypad. The calling card platform 40 may then verify that the calling card ID entered by the cardholder has been registered with the calling card platform 40. According to an embodiment of the present invention, the calling card platform 40 may also verify that the calling card ID entered by the cardholder has an available monetary credit or a balance available to it.

At step 90, if the calling card ID has not been registered with the calling card platform 40, then at step 100 the calling card platform 40 may give the cardholder a variety of options. For example, at step 100 the calling card platform 40 may give the cardholder the option to create an account with the calling card platform 40. Alternatively at step 100, the calling card platform 40 may terminate the call. As yet another alternative, the calling card platform 40 may direct the cardholder to a website associated with the calling card platform 40 so that the cardholder may learn about the benefits of creating an account with and using the calling card platform. As yet another alternative, the calling card platform 40 may give the cardholder the opportunity to use free or temporary options offered by the calling card platform 40.

Also at step 90, if the calling card ID has been registered with the calling card platform 40, then at step 110, according to an embodiment of the present invention, the cardholder is logged in to the calling card platform 40 and the calling card platform 40 will prompt the cardholder for a name of a person or place to call. After the cardholder states the name of a person or place to call, at step 120 the calling card platform 40 will attempt to match the name spoken by the cardholder with one of the names stored previously by the cardholder at step 50. According to an embodiment of the present invention, the calling card platform 40 may use voice recognition technology to match the name spoken by the cardholder with one of the names previously stored by the cardholder.

In addition, according to another embodiment of the present invention, the calling card platform 40 may rate the recognition of the name by a percentage of accuracy. For example, if the calling card platform 40 uses voice recognition technology to determine that the name spoken by the cardholder matches 80% of a name stored in a database used in the calling card platform 40, the calling card platform 40 may give that name an accuracy rating of 80%. In addition, the calling card platform 40 may be configured such that an accuracy rating may need to meet a predetermined threshold before automatically dialing the phone number associated with the name spoken by the cardholder. For example, according to an embodiment of the present invention, if a predetermined accuracy threshold is set at 80%, the accuracy rating given to a name spoken by the cardholder must be at least 80% before the calling card platform 40 will automatically dial the phone number associated with the name spoken by the cardholder. If the accuracy rating given to a name spoken by the cardholder is 80% or greater, for example, then the calling card platform 40 may automatically dial the phone number associated with the name spoken by the cardholder but may also repeat the name back to the cardholder using text-to-speech technology, or by playing back a recorded name to the cardholder, or by some other method known in the art to indicate to the cardholder the name of the person or place that the calling card platform 40 is calling.

If, however, the name recognized by the calling card platform 40 falls below the accuracy rating set by the calling card platform 40, such as, for example, 79% or less, the calling card platform 40 may confirm the name and the number with the cardholder before dialing. For example, the calling card platform 40 may respond to the cardholder by saying something such as, “Did you say ‘call Mom in Spain’?” or the like.

At step 130, once the calling card platform 40 confirms a match of the name of the person or place to be called, the calling card platform 40 places the call.

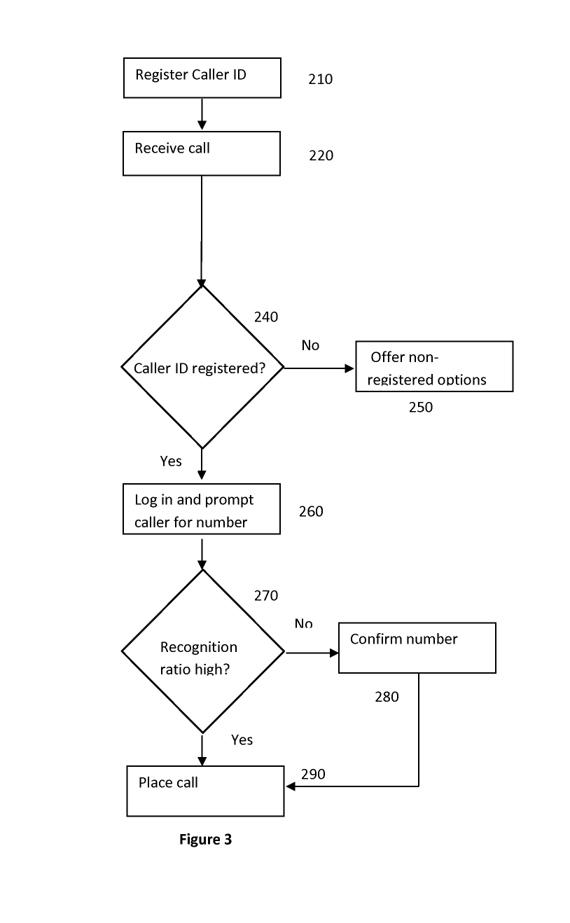

A method for a voice operated calling card system according to yet another embodiment of the present invention is shown in FIG. 3. In FIG. 3, at step 210 the cardholder registers his or her calling card ID with the calling card platform 40. The calling card ID may be the cardholder's telephone number assigned to the cardholder's smartphone, for example. The calling card ID may be registered with the calling card platform 40 by storing the calling card ID in a database.

At step 220, the calling card platform 40 receives a call from a cardholder. After the calling card platform 40 receives a call from a cardholder, at step 230 the calling card platform 40 verifies that the cardholder's calling card ID is registered with the calling card platform 40. For example, according to an embodiment of the present invention, if the cardholder, at step 210, registered his or her smartphone telephone number with the calling card platform 40 as the cardholder's calling card ID, then at step 220, if the calling card platform 40 receives a call from the cardholder using the same smartphone with which the cardholder originally registered, the calling card platform 40 can automatically verify registration of the cardholder's calling card ID upon receipt of a call from that smartphone.

At step 240, if the calling card ID has not been registered with the calling card platform 40, then at step 250 the calling card platform 40 may give the cardholder a variety of options applicable to non-registered calling card IDs. If the calling card ID has been registered with the calling card platform 40, then at step 260, according to an embodiment of the present invention, the cardholder is logged in to the calling card platform 40 and the calling card platform 40 prompts the cardholder for a number to call. After the cardholder states the number to call, at step 270 the calling card platform 40 will attempt to confirm the number spoken by the cardholder. According to an embodiment of the present invention, the calling card platform may use voice recognition technology to confirm the number spoken by the cardholder.

In addition, according to another embodiment of the present invention, the calling card platform 40 may rate the recognition of the number by a percentage of accuracy. For example, if the calling card platform 40 uses voice recognition technology to determine that the calling card platform 40 recognized 90% of the number spoken by the cardholders, the calling card platform 40 may give the number a recognition ratio of 90%. In addition, the calling card platform 40 may be configured such that a recognition ratio may need to meet a predetermined threshold before automatically dialing the phone number spoken by the cardholder. For example, according to an embodiment of the present invention, if a predetermined recognition ratio is set at 90%, the recognition ratio given to a number spoken by the cardholder must be at least 90% before the calling card platform will automatically dial the phone number spoken by the cardholder. If the recognition ratio given to a number spoken by the cardholder is 90% or greater, for example, then the calling card platform 40 may dial the number automatically at step 290.

If, for example, the recognition ratio of the number spoken by the cardholder is less than the recognition ratio set by the calling card platform 40, the calling card platform 40 may confirm the number to dial at step 280 before dialing the number automatically at step 290. One advantage of the present embodiment of the invention is that, among other things, the cardholder can simply say a number to dial, rather than manually entering it, thus eliminating the need to dial ten or more digits using the keypad.

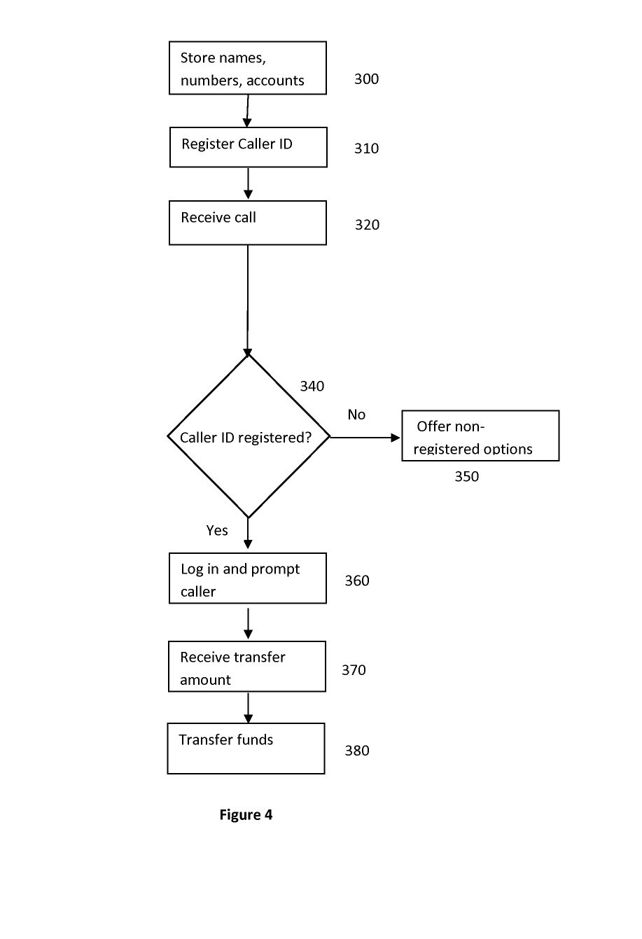

A method for a voice operated calling card system according to yet another embodiment of the present invention is shown in FIG. 4. In FIG. 4, at step 300 the names and associated telephone numbers of persons or places which a cardholder who has enrolled with the calling card platform 40 may call are stored in the calling card platform 40. In addition, account numbers where the cardholders store funds, such as a bank account number or a credit card account number, for example, may also be stored in the calling card platform 40. According to an embodiment of the present invention, the names, associated telephone numbers and account numbers may be stored in the calling card platform 40 via a website associated with the calling card platform 40. The names, telephone numbers and account numbers may be stored in one or more databases, such as a relational database, for example.

Next, at step 310 in FIG. 4, the cardholder registers his or her calling card ID with the calling card platform 40. The calling card ID may be the cardholder's telephone number assigned to the cardholder's smartphone, for example. The calling card ID may be registered with the calling card platform 40 by storing the calling card ID in a database associated with the calling card platform 40. In addition, the cardholder may link the calling card ID with one or more account numbers stored at step 300. According to another embodiment of the present invention, the cardholder may link the calling card ID with one or more social network accounts or email addresses stored at step 300. The linking of the calling card ID with one or more account numbers may be done at a website associated with the calling card platform 40. The account numbers and related information may be stored in an encrypted fashion and may be stored in compliance with security standards that are well-known in the art, such as the Payment Card Industry (PCI) Security Standard.

At step 320 in FIG. 4, the calling card platform 40 receives a call from a cardholder. The cardholder may dial the calling card platform 40 from any telephone the cardholder may have available, such as a smartphone, feature phone, mobile phone, analog telephone and the like. After the calling card platform 40 receives a call from a cardholder, at step 330, the calling card platform 40 determines if the calling card ID has been registered with the calling card platform 40. If the calling card ID has not been registered with the calling card platform 40, then at step 350 the calling card platform 40 may give the cardholder a variety of options for non-registered calling card IDs. For example, at step 350 the calling card platform 40 may give the cardholder the option to create an account with the calling card platform 40. Alternatively at step 350, the calling card platform 40 may terminate the call. As yet another alternative, the calling card platform 40 may direct the cardholder to a website associated with the calling card platform 40 so that the cardholder may learn about the benefits of creating an account with and using the calling card platform. As yet another alternative, the calling card platform 40 may give the cardholder the opportunity to use free or temporary options offered by the calling card platform 40.

Also at step 340, if the calling card ID has been registered with the calling card platform 40, then at step 360, according to an embodiment of the present invention, the cardholder is logged in to the calling card platform 40 and the calling card platform 40 prompts the cardholder for a name or a number to call. However, according to the embodiment of the invention shown in FIG. 4, after the calling card platform 40 prompts the cardholder for a name or a number to call, the cardholder, rather than stating a name or a number, may state something that indicates to the calling card platform 40 that the cardholder wants to transfer funds to his or her calling card ID account balance. For example, after the calling card platform 40 prompts the cardholder for a name or a number to call, the cardholder may say “recharge” or “add funds” or “top up” or the like.

Once the calling card platform 40 has prompted the cardholder and the cardholder has indicated to the calling card platform 40 that the cardholder wants to transfer funds to his or her calling card ID account balance, at step 370 the cardholder may indicate an amount of money transferred to the cardholder's calling card ID account balance. The amount of money to be transferred may be designated in United States dollars or may be designated in any other currency. According to an embodiment of the present invention, the transfer may be associated with the cardholder's email account or social networking accounts, such as TWITTER, FACEBOOK, and the like.

At step 380, the calling card platform 40 will begin the process of transferring funds from the cardholder's bank account or credit card account to the cardholder's calling card ID account. For example, according to an embodiment of the present invention, the calling card platform 40 will confirm with the cardholder the amount of money to be transferred. Once the amount of money to be transferred is confirmed, the calling card platform 40 will then confirm which of the cardholder's accounts should be used for the transfer. For example, if the cardholder has both a bank account and a credit card account linked to the cardholder's calling card ID, or, for example, more than one bank account linked to the cardholder's calling card ID, the calling card platform 40 may prompt the cardholder to identify the account from which to transfer funds, at which point the cardholder may give the calling card platform 40 a voice response identifying the appropriate account. Once the calling card platform 40 has confirmed the account from which to transfer funds, the funds are transferred to the cardholder's calling card ID account, thereby allowing the cardholder to continue making calls using the cardholder's voice operated calling card.

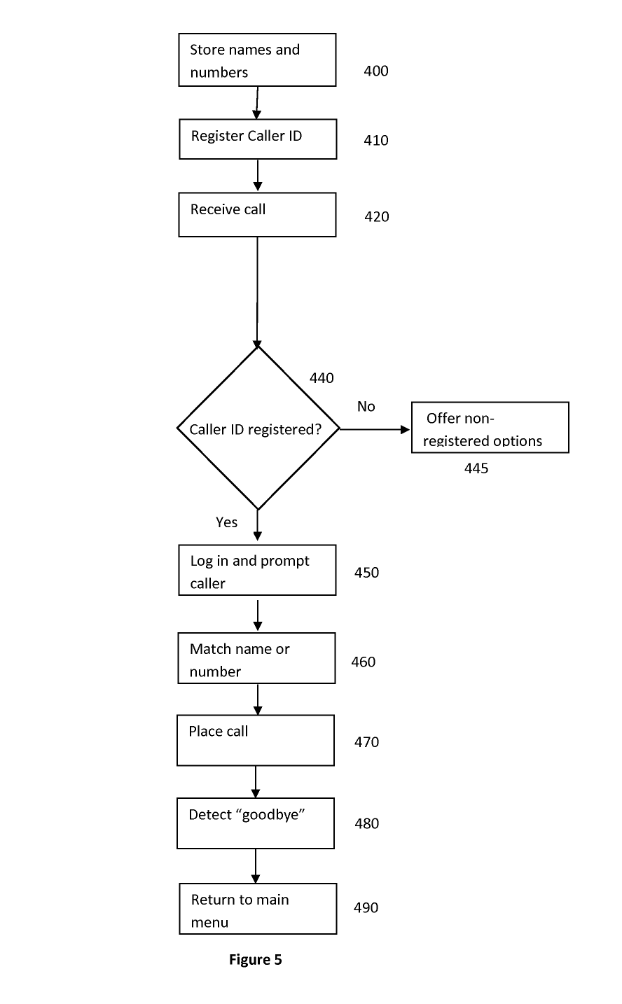

A method for a voice operated calling card system according to yet another embodiment of the present invention is shown in FIG. 5. In FIG. 5, at step 400 the names and associated telephone numbers of persons or places which a cardholder who has enrolled with the calling card platform 40 may call are stored in the calling card platform 40. According to an embodiment of the present invention, the names and associated telephone numbers may be stored in the calling card platform 40 via a website associated with the calling card platform 40. The names and telephone numbers may be stored in one or more databases, such as a relational database, for example.

At step 410, the cardholder registers his or her calling card ID with the calling card platform 40. The calling card ID may be the cardholder's telephone number assigned to the cardholder's smartphone, for example. The calling card ID may be registered with the calling card platform 40 by storing the calling card ID in a database.

At step 420 in FIG. 5, the calling card platform 40 receives a call from a cardholder. After the calling card platform 40 receives a call from a cardholder, at step 440 the calling card platform 40 verifies that the cardholder's calling card ID is registered with the calling card platform 40. For example, according to an embodiment of the present invention, if the cardholder, at step 410, registered his or her smartphone telephone number with the calling card platform 40 as the cardholder's calling card ID, then at step 420, if the cardholder calls the calling card platform 40 with the same smartphone with which the cardholder originally registered, the calling card platform 40 can automatically verify registration of the cardholder's calling card ID upon receipt of a call from that smartphone.

At step 440, if the calling card ID has not been registered with the calling card platform 40, then at step 445 the calling card platform 40 may give the cardholder a variety of options for non-registered calling card IDs. If the calling card ID has been registered with the calling card platform 40, then at step 450, according to an embodiment of the present invention, the cardholder is logged in to the calling card platform 40 and the calling card platform 40 prompts the cardholder for a name or number to call. After the cardholder states the name or number to call, at step 460 the calling card platform 40 will attempt to match the number or number spoken by the cardholder with a name or number stored in a database used by the calling card platform 40. According to an embodiment of the present invention, the calling card platform may use voice recognition technology to match the number or number spoken by the cardholder. Once the name or number has been matched, the calling card platform 40 may place the call at step 470.

According to the embodiment of the invention shown in FIG. 5, the calling card platform 40 may detect a word, statement or signal that indicates the cardholder is ending or has ended the call. For example, the calling card platform 40 may detect that the cardholder or the person to whom the cardholder is talking has said the word “goodbye” or “see you later” or the like or, alternatively, the calling card platform 40 may detect a dropped or non-existent network signal. Under these scenarios, the calling card platform 40 may determine that the call has ended and, at step 490, may return to the main menu of the calling card platform 40, giving the cardholder the option of entering another name or number to call or giving the cardholder other options that may be available for the cardholder's account. According to the present embodiment of the invention, there is no need to enter additional numbers, symbols or commands to indicate to the calling card platform 40 that the call has ended or that the cardholder would like to place an additional call.

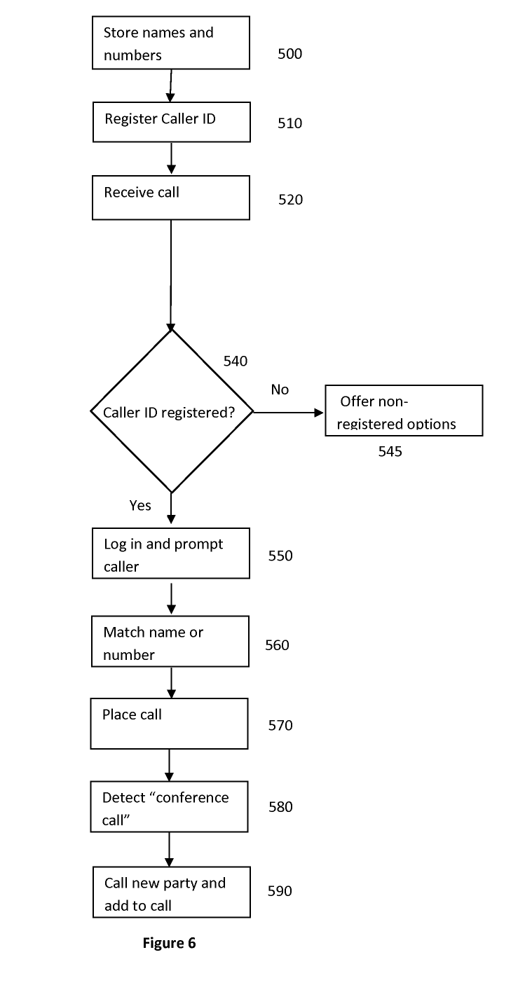

A method for a voice operated calling card system according to yet another embodiment of the present invention is shown in FIG. 6. In FIG. 6, at step 500 the names and associated telephone numbers of persons or places which a cardholder who has enrolled with the calling card platform 40 may call are stored in the calling card platform 40. According to an embodiment of the present invention, the names and associated telephone numbers may be stored in the calling card platform 40 via a website associated with the calling card platform 40. The names and telephone numbers may be stored in one or more databases, such as a relational database, for example.

At step 510, the cardholder registers his or her calling card ID with the calling card platform 40. The calling card ID may be the cardholder's telephone number assigned to the cardholder's smartphone, for example. The calling card ID may be registered with the calling card platform 40 by storing the calling card ID in a database.

At step 520 in FIG. 6, the calling card platform 40 receives a call from a cardholder. After the calling card platform 40 receives a call from a cardholder, at step 540 the calling card platform 40 verifies that the cardholder's calling card ID is registered with the calling card platform 40. For example, according to an embodiment of the present invention, if the cardholder, at step 510, registered his or her smartphone telephone number with the calling card platform 40 as the cardholder's calling card ID, then at step 520, if the cardholder calls the calling card platform 40 with the same smartphone with which the cardholder originally registered, the calling card platform 40 can automatically verify registration of the cardholder's calling card ID upon receipt of a call from that smartphone.

At step 540, if the calling card ID has not been registered with the calling card platform 40, then at step 545 the calling card platform 40 may give the cardholder a variety of options for non-registered calling card IDs. If the calling card ID has been registered with the calling card platform 40, then at step 550, according to an embodiment of the present invention, the cardholder is logged in to the calling card platform 40 and the calling card platform 40 prompts the cardholder for a name or number to call. After the cardholder states the name or number to call, at step 560 the calling card platform 40 will attempt to match the number or number spoken by the cardholder with a name or number stored in a database used by the calling card platform 40. According to an embodiment of the present invention, the calling card platform may use voice recognition technology to match the number or number spoken by the cardholder. Once the name or number has been matched, the calling card platform 40 may place the call at step 570.

According to the embodiment of the invention shown in FIG. 6, at step 580 the calling card platform 40 may detect a word, statement or signal that indicates that the cardholder would like to add one or more persons to the call that the cardholder is already on, thereby creating a “conference call.’ For example, the calling card platform 40 may detect that the cardholder has said the word “conference” or “conference call.” Alternatively, if the calling card platform 40 provides for symbols to be entered to indicate the desire for a conference call, such as entering consecutive “*” keys or some alternative designation, for example, the cardholder may simply state “star star” or may depress consecutive “*” keys on the telephone keypad to indicate to the calling card platform 40 that the cardholder wants to add other persons to the call. Under these scenarios, the calling card platform 40 may prompt the cardholder to indicate the name or number of the person the cardholder would like to add to the call. Then, after the cardholder states the name or number of the person to add to the call, at step 590 the calling card platform 40 can call that person and add them to the call. When the person called answers the call, the calling card platform 40 can prompt the person to say something such as “join the call” “add me to the call” or the like. Alternatively, the calling card platform 40 can indicate to the person called that pressing the “*” key or some other key or symbol will connect the person called to the conference call. Upon the calling card platform 40 detecting that the person called has said “join the call” or has pressed the “*” key or the like, the calling card platform may connect the person to the conference call.

According to the present embodiment of the invention, the card calling platform 40 can be configured to add any number of persons the cardholder would like to add to the call. In addition, the calling card platform 40 may be configured such that each person on the conference call can be billed to the cardholder's calling card ID account. Using the present embodiment of the invention, a cardholder can hold a conference call from any telephone available to the cardholder, even if the telephone does not have 3-way calling or other conferencing features associated with it. Moreover, under the present embodiment of the invention, there is no need to disseminate a conference call number and conference call ID to any of the parties the cardholder would like on the conference call.

The advantages of embodiments of the present invention are numerous. For example, according to the embodiments of the present invention, the need to enter a PIN number or code to use a calling card has been eliminated. In addition, according to the embodiments of the present invention, because the calling card platform 40 can be configured with voice recognition technology, the need to dial digits to dial a destination number has also been eliminated. Embodiments of the present invention also have the advantage that the need to confirm numbers to dial if a name or number recognition is above a predetermined threshold or accuracy level is eliminated. Thus, international long distance calls can be made simply by dialing a local or toll free number to access the calling card platform 40. Moreover, if a cardholder programs an access number to the calling card platform 40 into a speed dial key on the cardholder's phone, the cardholder will be able to make international long distance calls simply by pressing one button and speaking into the phone.

While particular embodiments of the present invention have been shown and described, it will be obvious to those skilled in the art that the invention is not limited to the particular embodiments shown and described and that changes and modifications may be made without departing from the spirit and scope of the invention.

What is claimed is:

1. A system for voice operated communication assistance comprising:
a communications device, the communications device being able to communicatively couple to a network; and
an application hosted by an application server, the application server communicatively coupled to a network,
wherein the application is configured to accept a voice command from the communications device, and
wherein the application is further configured to associate a user of the communications device access to with a calling card.

2. The system of claim 1, wherein the communications device is a mobile telephone.

3. The system of claim 2, wherein the mobile telephone is a smartphone.

4. The system of claim 1, wherein the communications device is an analog telephone.

5. The system of claim 2, wherein the application associates the user of the mobile telephone with the calling card using a telephone number of the mobile telephone.

6. The system of claim 1, wherein the application associates funds with the calling card.

7. The system of claim 6, wherein the calling card purchases a service using the funds.

8. The system of claim 7, wherein the service is long distance telephone calling.

9. A method for voice operated communication assistance comprising:
providing a communications device, the communications device being able to communicatively couple to a network; and
providing an application hosted by an application server, the application server communicatively coupled to a network,
wherein the application is configured to accept a voice command from the communications device, and
wherein the application is further configured to associate a user of the communications device access to with a calling card.

10. The method of claim 9, wherein the communications device is a mobile telephone.

11. The method of claim 10, wherein the mobile telephone is a smartphone.

12. The method of claim 9, wherein the communications device is an analog telephone.

13. The method of claim 9, wherein the application associates the user of the mobile telephone with the calling card using a telephone number of the mobile telephone.

14. The method of claim 9, wherein the application associates funds with the calling card.

15. The method of claim 14, wherein the calling card purchases a service using the funds.

16. The method of claim 15, wherein the service is long distance telephone calling.
